(19) United States
(12) Patent Application Publication
(10) Pub. No.: US 2006/0141438 A1
(43) Pub. Date: Jun. 29, 2006

(54) Remote instruction system and method

(75) Inventors: Zechary Chang, Taipei (TW); Pinky Ma, Beijing (CN); Sherry Xia, Beijing (CN); Linda Xu, Beijing (CN)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Inventec Corporation, Taipei (TW)

(21) Appl. No.: 11/021,203

(22) Filed: Dec. 23, 2004

(51) Int. Cl. G09B 3/00

(52) U.S. Cl. 434/350

(57) ABSTRACT

A remote instruction system and method includes an exercise editing module for instructor ends to edit exercises in an exercise database and a student learning module to access the exercises in the exercise database and display the exercises at student ends. Students learn and test based on the exercises. An error statistics module is provided to mark questioned exercises based on statistics results. A question marking module receives the questioned exercises marked by students, and a question answering module is linked to the instructor ends and student ends to implement teaching activities and enable the instructor to teach the questioned exercises and answer student's questions.

### FIELD OF THE INVENTION

The present invention relates to an instruction platform and method, and particularly to a remote instruction system and method that are capable of automatically accessing exercise data.

### BACKGROUND OF THE INVENTION

The rapid advance of Internet developments has spawned a wide variety of Internet applications. Remote instruction is an important developing direction in network applications. The remote instruction based on computer network technology and multimedia technology is an extension of conventional school education. It also is an important information sharing service in the network environment.

At present most remote instruction programs target the general public, training institutions and internal training of large and medium enterprises. Those instruction activities are built on a remote instruction network platform. A good instruction network system platform affects the instruction quality and development of network curricula. The conventional remote instructions mostly focus on students. The main concern is to improve learning interest and learning time flexibility. While some remote instruction systems have provided functions such as courses selection for instructors and students, curriculum management, member management, and the like, they have some common problems, such as an inadequate database content, limited instruction data, complicated updating process for system database, and the like. It often happens that a system is obsolete after having been repeatedly used by students.

Hence to provide a universal instruction platform that targets instructors and students and is adaptable to various subjects and enables the instructors to flexibly update the contents of database is an urgent issue remaining to be resolved in remote instructions.

### SUMMARY OF THE INVENTION

In view of the aforesaid problems, the primary object of the present invention is to provide a universal instruction system and method that targets instructors and students and is adaptable to various subjects and enables the instructors to flexibly update the content of a database without relying on other systems.

In order to achieve the foregoing object, the remote instruction system according to the invention aims to automatically access exercise data and generate interactions between instructor ends and student ends. It includes an exercise database to store exercises for instructors to teach and students to learn and use; an exercise editing module for the instructor ends to edit the exercises in the exercise database; a student learning module to access the exercises in the exercise database and display the exercises on the student ends, while the students learn and test based on the exercises and get test results; an error statistics module to perform statistics of the test results for the student ends, and mark questioned exercises based on the statistics results; a question marking module linking to the student learning module to receive questioned exercises marked by the students; and a question answering module linking to the instructor ends and student ends to implement teaching activities and enable the instructors to teach the questioned exercises and answer student's questions.

In addition, the remote instruction method according to the invention can automatically access the exercise data and generate comprehensive interactions between the instructor ends and the student ends. First, the instructors edit the exercise data and store the exercise data in the exercise database, and access an exercise from the exercise database and send it to the student ends; the students try to learn from the content of the exercise, and do tests and mark questioned exercises; perform error statistics based on test results and mark questioned exercises based on the statistics results; finally the instructors teach the questioned exercises.

The remote instruction system and method according to the invention consolidates the powerful services of network education and training, and provides a full scope of information services, instruction management and organization services for the instructors and the students. All interfaces are defined to fixed platforms, and are simple, easy to understand and control. The content of the exercise database may be modified and updated anytime by the instructors. It greatly improves convenience for the instructors and students.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of an overall architecture of the remote instruction system of the invention.

FIG. 2 is a schematic view of the architecture of an embodiment of the invention.

FIG. 3 is an operation flowchart of the remote instruction method of the invention.

FIGS. 4a through 4r are schematic views of interface embodiments of the invention.

### DESCRIPTION OF THE PREFERRED EMBODIMENTS

Remote instruction is an interactive education mode that combines audio, video and data and implements through networks to overcome the limitation of time and geographic conditions, and fully utilize excellent teaching resources.

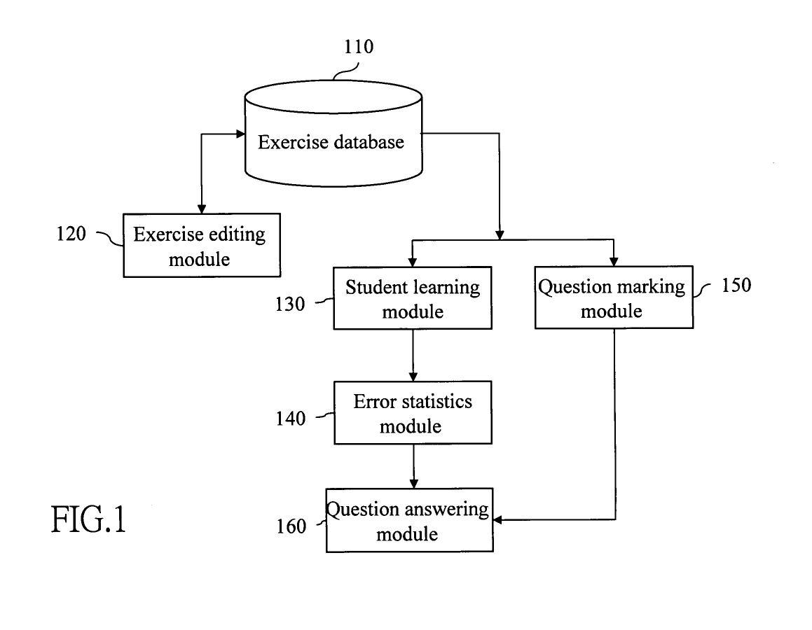

The remote instruction system and method according to the invention can automatically access exercise data and generate comprehensive interactions between instructor ends and student ends. Refer to FIG. 1 for module architecture of an instruction platform of the invention. It includes an exercise-editing module 120 linking to a student learning module 130 and an exercise database 110 to enable instructors to edit the exercises and students to do the exercises in the database. The student-learning module 130 is connected to a question-marking module 150 which allows students to add bookmarks on questioned exercises during practice. And an error exercise table may be derived for instructor reference. The student learning module 130 also is connected to an error statistics module 140 which processes statistics such as generating student practice results, student achievements, and ranking according to the achievements, and the like. More detailed functions of each module are elaborated as follows:
1. The exercise database 110 stores exercises to be used by the instructors to teach and the students to practice. The exercise contents may be updated anytime desired. The exercise database may store exercises or is an empty database to receive inputs from the instructors anytime desired.
2. The exercise editing module 120 enables the instructors to do editing for the exercises in the exercise database, including input, modification, delete and the like. The instructors can classify the exercises, such as practice exercises and test exercises. The practice exercises may be freely accessed by the students for practice. For the test exercises, the publication time of the test exercises is determined by the instructors. The exercises that are prohibited from publishing may be marked by the system with a special notation. If the students try to access these exercises, the system rejects the access.
3. The student learning module 130 aims to access the exercises in the exercise database and display the exercises on the student ends to enable the students to practice and test, and also get the test results.
4. The error statistics module 140 processes statistics of the tests at the student ends, and marks questioned exercises based on the statistic results, and also calculates student achievements based on mistake numbers obtained while processing the test results.
5. The question-marking module 150 is linked to the student learning module to receive questioned exercises marked by the students.
6. A question-answering module 160 is linked to the instructor ends and student ends to implement teaching activities and enable the instructors to teach the questioned exercises and answer student's questions. It establishes an online answering room for the instructors and students, and implements video and audio communications. It includes an answer database set up by the instructors based on the questioned exercises. The answer database provides display services at the student ends. It also includes an interactive electronic whiteboard.

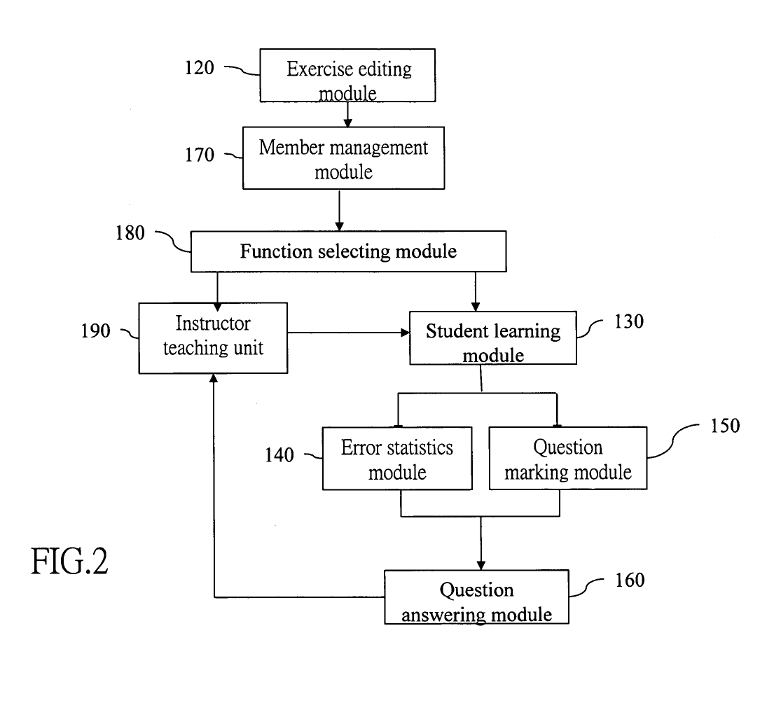

Refer to FIG. 2 for the architecture of an embodiment of the invention. The system may further include a member management module 170 for the instructors and students to do registration and enter identifications and authentication, and monitor all operation authorizations. The question-answering module 160 further includes an instructor teaching unit 190 to implement teaching activities between the instructors and students. After users have passed identification authentication, they can select functions through a function-selecting module 180 to enter a learning process or an instructor teaching process.

The exercise database further is connected to an exercise generation module, which automatically generates exercises. It includes a structure setting module to set up the structure of the exercise database according to teaching requirements, an interface generation module to generate corresponding user interfaces according to the structure of the exercise database, an input receiving module linking to the interface generation module to receive exercise data input by the instructors through the user interfaces, and an exercise data generation module to store instruction contents in corresponding locations of the exercise database.

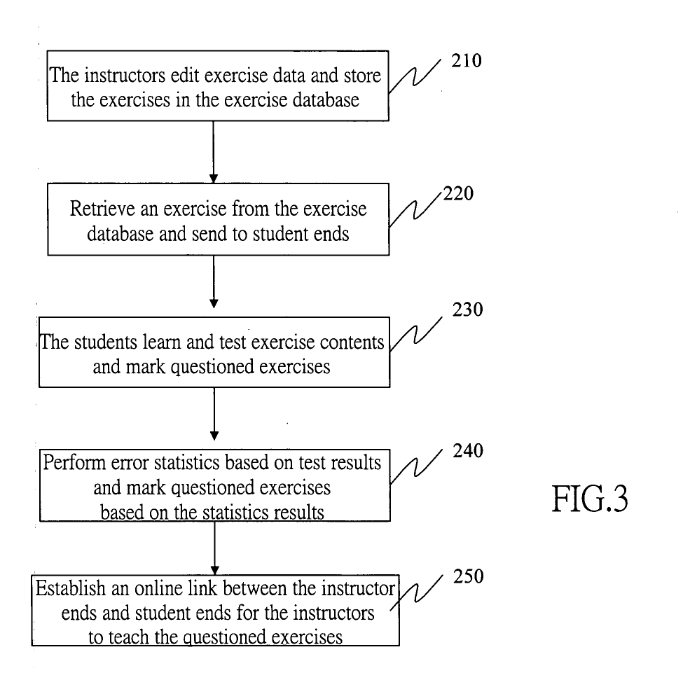

Refer to FIG. 3 for the process flow of the remote instruction method of the invention. It includes the following procedure: first, the instructors edit the exercise data and store the exercises in the exercise database (step 210); the editing includes input, modification and delete operations. Next, retrieve an exercise from the exercise database and send it to the student ends (step 220). The students learn and test exercise contents and mark questioned exercises (step 230). Process error statistics based on the test results and mark the questioned exercises (step 240). The process of error statistics includes calculating error statistics, and student achievements based on the error statistics. Finally establish an online link between the instructor ends and student ends for the instructors to teach the questioned exercises (step 250).

The automatic generating process of the exercise database that is suitable for student learning and instructor teaching include: first, establishing the structure of the exercise database; next, generating corresponding user interfaces according to the exercise database structure. The instructors enter exercise data through the user interfaces. The system receives the exercise data and stores them in the corresponding locations of the exercise database. After the exercises have been put in, the instructors can edit the exercises as desired. If the instructor thinks an exercise may be used for a test, the system will highlight “whether to publish the exercise” after the exercise has been entered through the exercise editing module to allow the instructor to make a selection. For the exercises that are prohibited from publishing, the system gives them a special mark. If the students try to select the prohibited exercises, the system rejects the selection. Hence the instructor does not have to send the exercises of a selected round to the students. The students can select the exercises for practice through networks by themselves.

Instructor teaching mentioned previously may be accomplished by establishing an online connection between the instructors and students and carried out through video and audio communications. An electronic whiteboard may also be set up for exchange between an instructor and the students. For students, it is like being in the same classroom with the instructor. And the instructor can give lectures, answer questions and solve problems raised by the students. Hence even if the instructor is physically a hundred miles away from the students, the students still can see and listen lectures given by the instructor through a screen. And the instructor can see the classroom through a remote video camera anytime on a screen. Students also can talk about their opinions and participate in classroom discussions. Interpretation of test exercises may be jointly accomplished by the instructor and students through the interactive electronic whiteboard.

A multimedia instruction is used as an example to further elaborate the invention as follows:

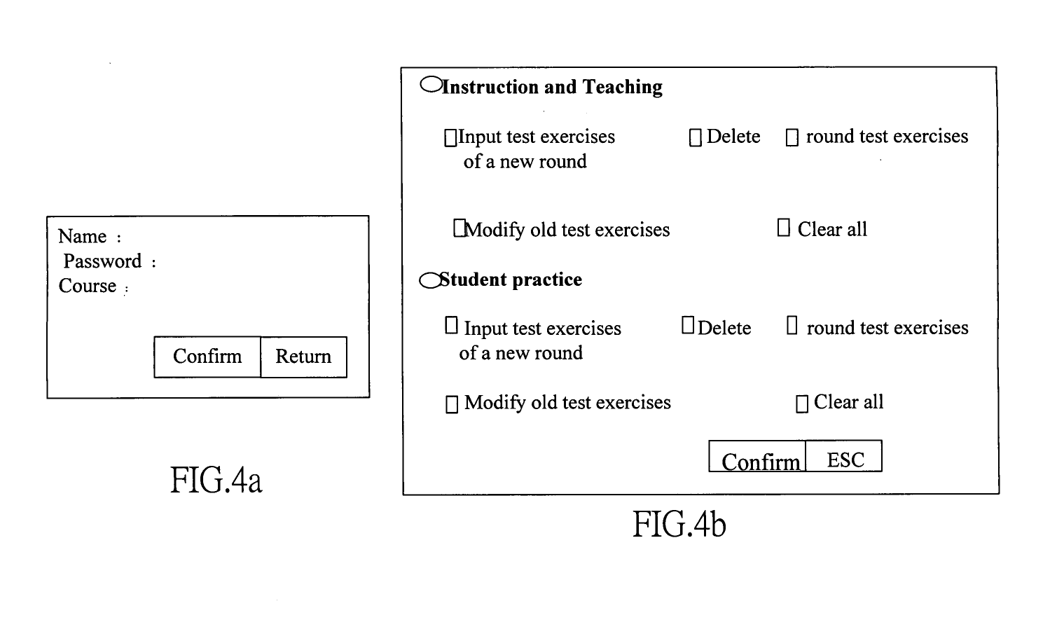

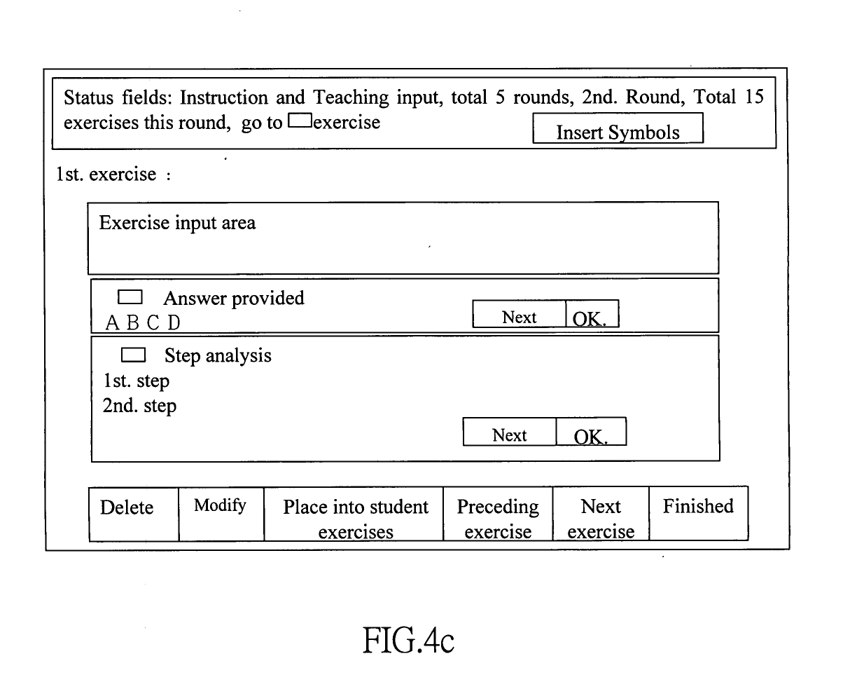

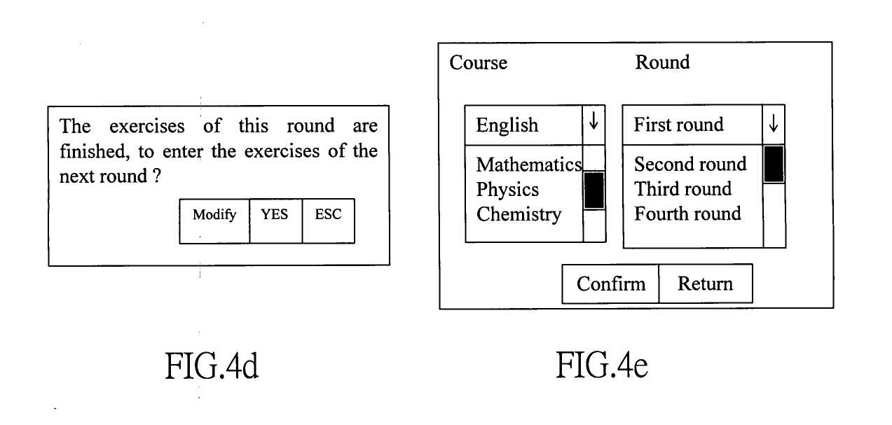

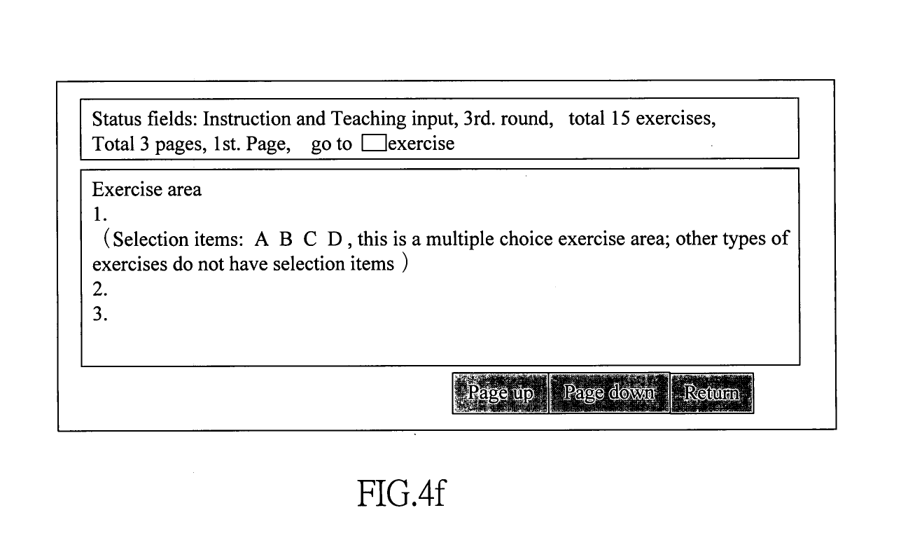

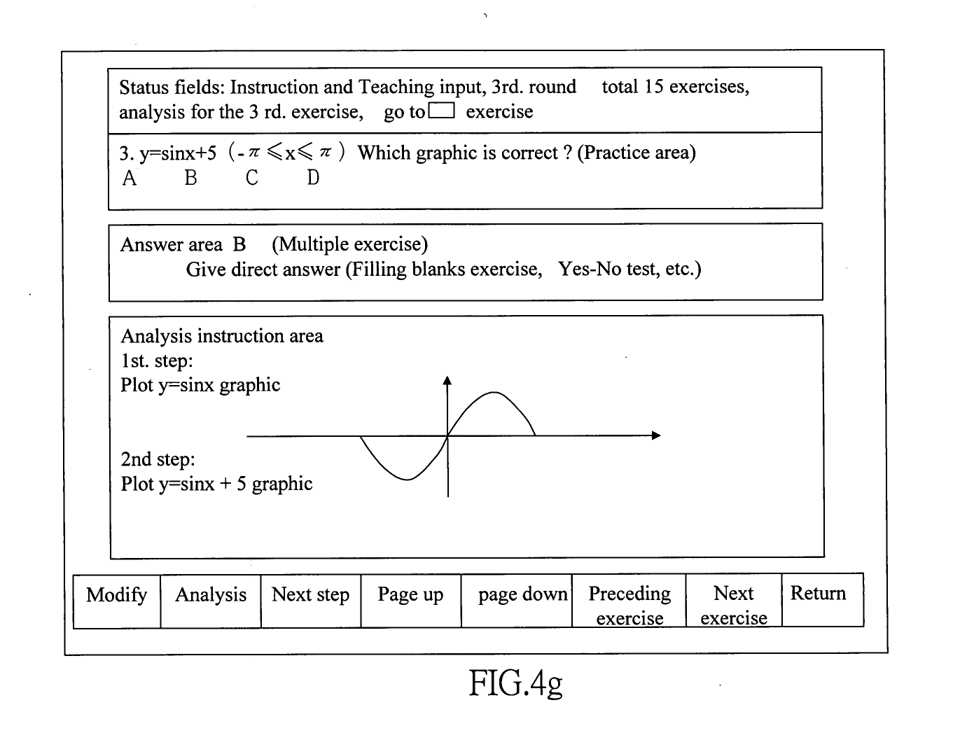

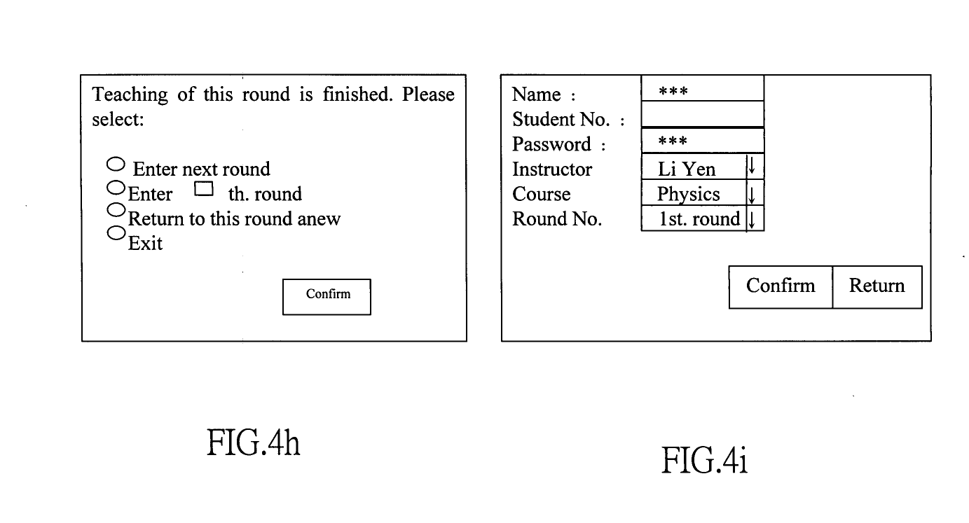

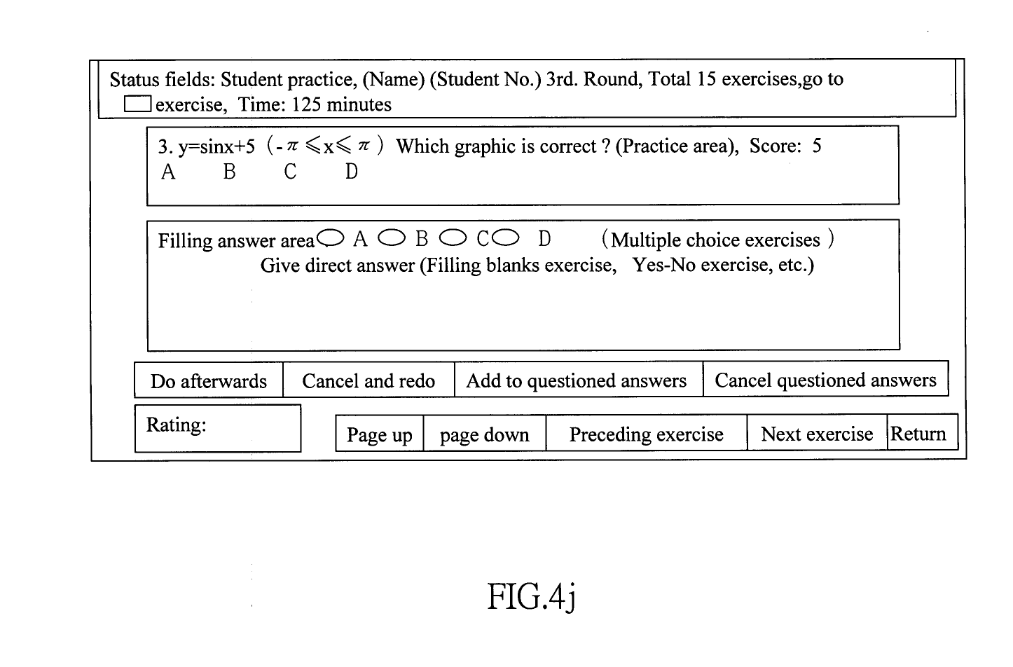

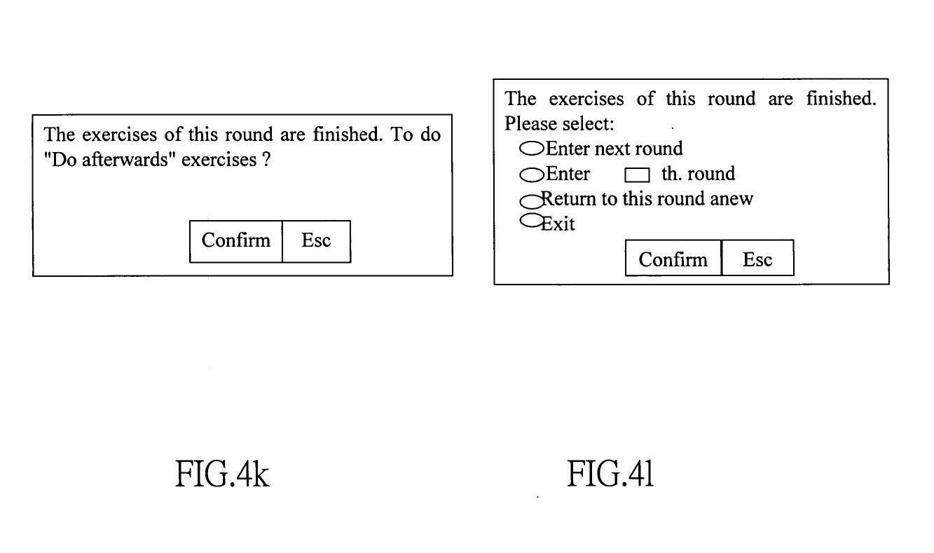

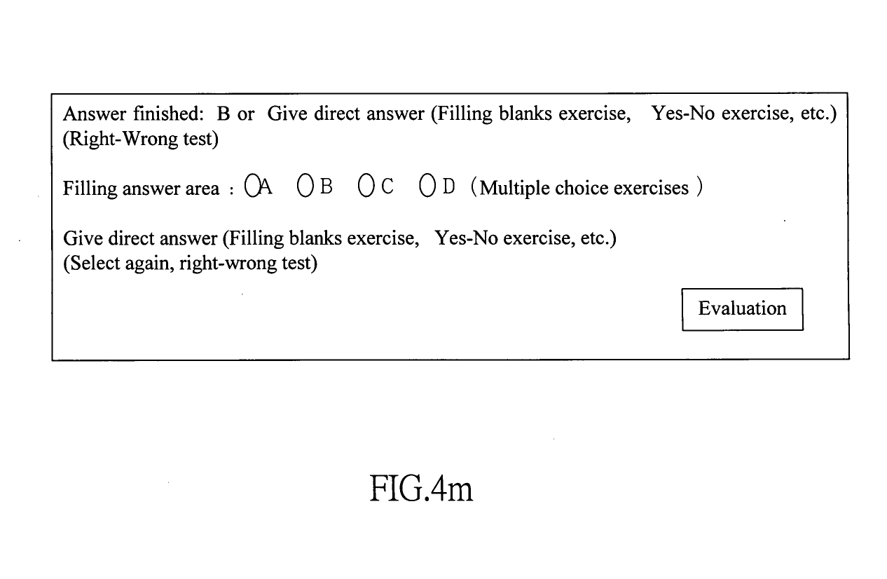

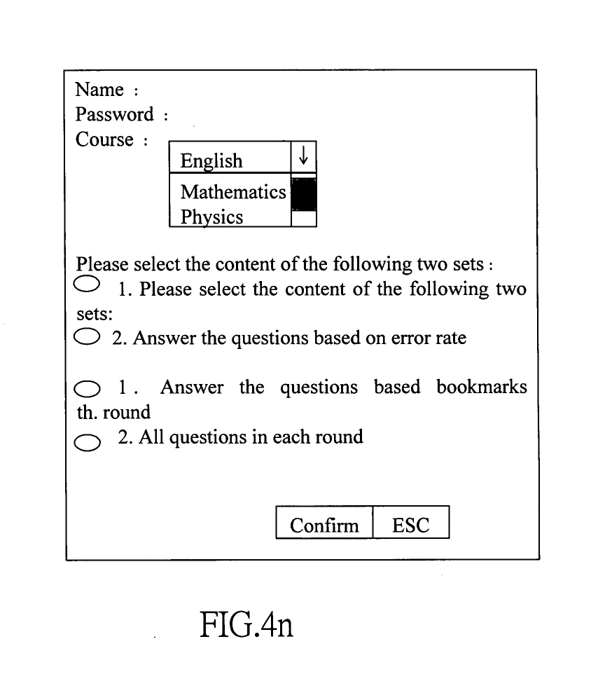

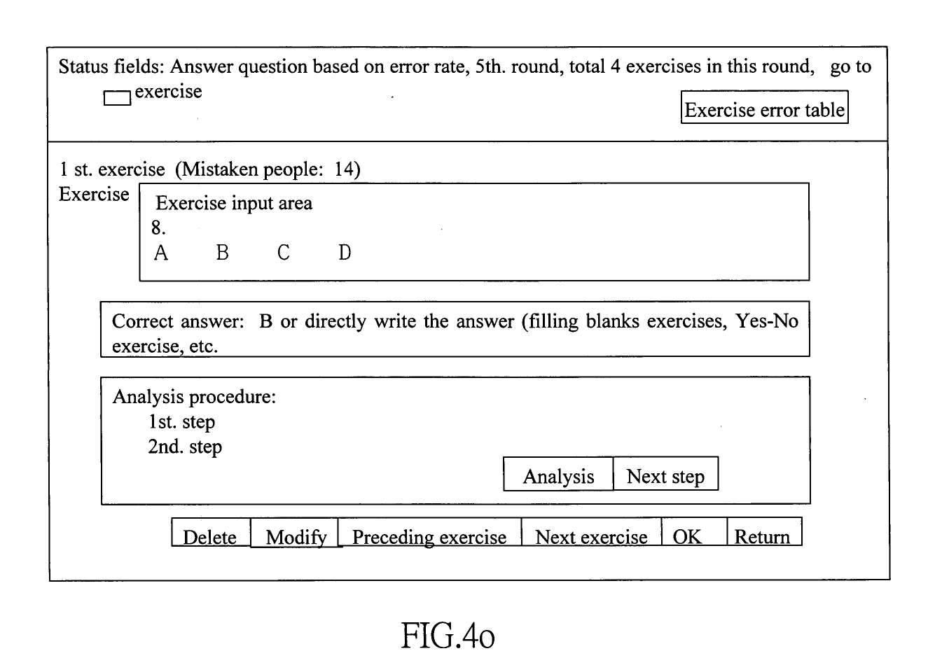

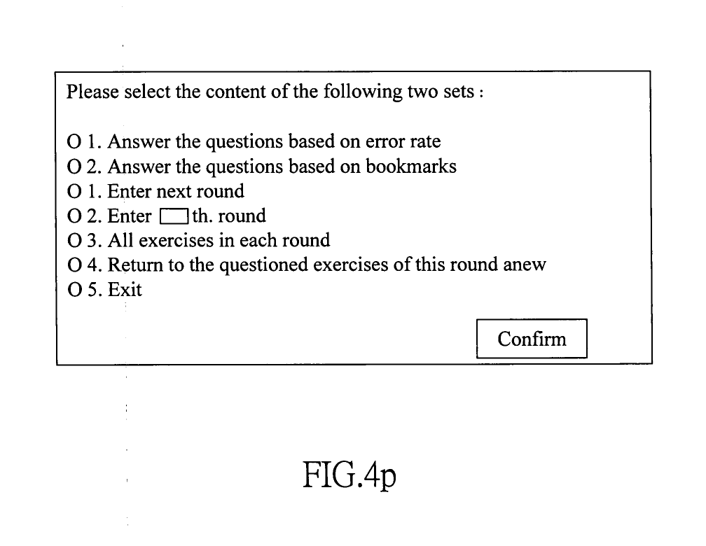

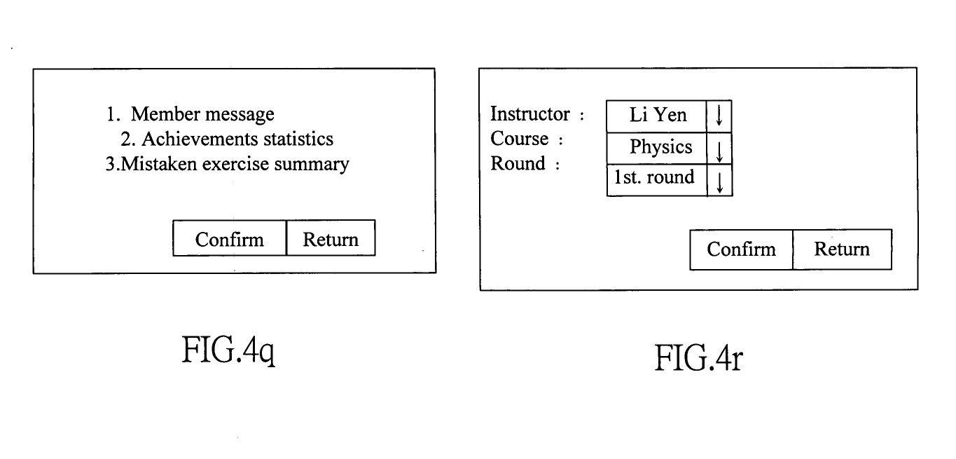

Refer to FIGS. 4a through 4r for the interfaces of an embodiment of the invention. FIGS. 4a through 4d are schematic views of the interfaces to input exercises. In the instruction platform of the invention instructors and students have to register first before logging on the system. FIG. 4a illustrates a logon interface displayed by the system for users to enter information such as name, password, course, and the like. Once a course is selected, the system automatically retrieves all symbols used in the course. The system accepts one instructor entering different courses or different instructors entering the same course. But the name and the course cannot be the same concurrently. Then highlight input selection for instruction exercise or student practice exercise as shown in FIG. 4b that must be selected for either one. Once selected, the following content is activated, and the instructor can make further selections. If the selection is to modify the old test exercise, a dialog window will appear to ask which round of test exercise has to be modified. If the selection is to delete or clear the exercises, the system highlights once “Confirm deletion/Clear”; after finish, return to the interface. After all exercises of a selected round have been deleted, the numbers of all the following rounds of exercises are automatically advanced by one and sequenced accordingly. Refer to FIG. 4c for an instruction teaching exercise input interface. While entering the exercise, the key of the “Insert symbol” may be selected to access a symbol frame for picking desired selections. There is a selection box ahead the “Whether to provide answer” (for multiple choice exercises) and “Whether to provide a step analysis”. Once the selection box is ticked, the contents for providing answer and step analysis below become effective; otherwise they are not effective. With the selection box picked, the character A and “1st. step” are automatically effective, and the characters after B and the step after the 2nd are not displayed. After having selected an answer to provide, press the character A (may be designed as a popup input frame), answer A may be entered. After having finished the answer “A”, press “Next” key, character B appears for entering answer B, and so on for entering other answers. After having finished the answer entering, depress OK to complete answer input. To correct any input error of subjects, select the modify key and the “Next One” and “Next Step” key to modify the individual selected answer and analysis step. Selecting the “Delete” key will delete the exercise. Once the exercise is deleted, one automatically advances the numbers of the following exercises. When “Place to student exercise” is selected, a selection frame pops up to ask “The round number and exercise number to be placed into”. Once confirmed, the existing exercise will be moved to the required location. The exercise may only be placed into a round not being practiced by any student; otherwise the system will indicate “The exercises in this round have been practiced!” If the exercise is to be inserted in the middle of exercises of a selected round, the sequence number of the following exercises is automatically shifted backwards by one and still in sequence. In the student exercises, if the round number is not yet established, the system automatically highlights “The round number is not yet established, want to establish a new round number in sequence?”. If “Confirm” is selected, the placing exercise is designated and located as the first exercise of the newly establishing last round. If the exercise is beyond the placing limit (for instance, the total exercise number of the round is 15, but the requested placing number is 18), the system will popup a highlight frame “This round includes total 15 exercises, whether to be placed on he 16th?). The input process prohibits illegal digits, such as negative, decimal, characters, etc., otherwise the system reports errors. If the entering round has a rating, before placing the exercise, the system will pop up a dialog frame to request filling in the rating of the exercise, otherwise the input is not accepted. To establish a new round, the system asks whether to set up rating. After selecting ‘yes’, a rating is entered, and all exercises in the selected round are considered tacitly including ratings; otherwise all the exercises are not assigned with a round number. Selecting the keys of “Preceding exercise” and “Next exercise” allows entering the preceding exercise and next exercise for editing or modifying. Enter an exercise number in the square box of “go to □ exercise” and execute, the selected exercise is displayed for editing. If the entering number is a mistake, the system pops up a dialog frame to highlight “No exercise found”. After all the exercises have been entered, depress the “Finish” key; a dialog frame is popup by the system to ask “Whether to enter input of the next round?” (As shown in FIG. 4d). If the user selects “Modify” key, he/she can revise the exercises of the round that have just finished the input operation. The system automatically positions at the first exercise. Select “Yes”, and finish the test exercises of the selected round, enter the test exercise input interface of the next round. Select “ESC”, the system returns to the interface of the upper level.

The student practice exercise input interface is basically the same as the instruction-teaching page. The difference is that the status fields indicate “Student practice input” without the “Place to student exercises” key. The instructor may select not to set up analysis content. Hence the step analysis area has two selection keys, one for “Whether analysis instruction is required”, and another for “Whether step analysis is required”. A correct answer area is added on the page beneath the provided answers to enable the instructor to enter the correct answer. Below the providing answer on the page, there is also a “Rating” selection frame. After having selected “Rating”, an input frame is activated and appears for entering the rating. When the “Rating” is not selected, it means that the exercise does not have rating. If the “Rating” was selected, but no rating is entered, the system highlights errors. When the “Rating” of the first exercise is selected, all the rest exercises in the same round are tacitly considered having selected rating, and the rating must be entered.

Refer to FIGS. 4e through 4h for the instruction teaching interfaces. After having entered the instruction-teaching module, a pull down list for courses and rounds is displayed (as shown in FIG. 4e). After having selected “Confirm”, enter the instruction teaching main interface as shown in FIG. 4f, press the “Return” key and the system returns to the selection page (system Home Page). FIG. 4g illustrates an analysis instruction page of an embodiment of an exercise. It also is an answer interface. After ticking the digital key on the main interface through the mouse, entering the answer interface is confirmed. On that interface, the answer is given directly. The analysis instruction content is empty at the beginning. After having entered an exercise number in the box of “go to [symbol] exercise” and execute, the system directly jumps to the selected exercise. Press the “Analysis” key, the analysis first step content appears (if the step analysis is not selected, all analysis contents are directly displayed). Press the “Modify” key, the system pops up a dialog window requesting to enter name and password. Only eligible users (i.e. instructors) are permitted to make modifications. After having confirmed a correct procedure, the exercise may be modified as desired. After having finished the modification, press “Preceding exercise”, “Next exercise” and “Return”, the system automatically stores the modified content. Press the “Next step” key, the analysis steps appear sequentially. If one page is not enough for displaying, the succeeding steps are automatically displayed on the next page. However, at that moment the next page still is not displayed. If the entire content of the second step has to be displayed on the next page, press the “Next step” key, this automatically includes the “Page down” function. (If stepwise instruction is not selected, the “Next step” key is ineffective, and “1st. step” is not displayed). After having pressed the “Page up” and “Page down” keys the system automatically turns a page. The ‘turn page’—function is limited to the answer interface, and cannot return to the main interface. After having pressed the “Preceding exercise” and “Next exercise” keys, the system automatically enters the answer interface of the preceding exercise and the next exercise. Press the “Return” key, the system returns to the main interface. After the exercises of the selected round have been finished, press the “Next exercise” key on the page where the last exercise of the selected round is located, the system pops up a dialog window (as shown in FIG. 4h). In this dialog window, only one item can be selected. Enter a round number in the box of Enter [symbol] ‘ . . . round’, the user can directly go to the selected round. It is also permitted to go back to the existing round for continuous instruction, then the system automatically returns to the first exercise of the existing round.

Refer to FIGS. 4i through 4m for the student practice interfaces. After having entered the student practice module, a dialog interface is displayed as shown in FIG. 4i. The fields containing “***” must be filled, or the system will issue an error message. Redundant student names are not permitted. Instructor, course and round number have respectively a pull down selection frame. The course category and round number have been set when a selected instructor enters the exercises. If the aforesaid three items are not coincidental after pressing “Confirm” key, the system highlights an error. After having pressed the “Confirm” key, enter the student practice main interface as shown in FIG. 4j. The main interface has two purposes: one is to serve as the practice interface of a new round for students to practice from the beginning; another one is the situation in which the exercises of the selected round have been practiced by the students, and the selected round may be modified to serve as the practice pages of a new round. The full mark of ? ? ? each round is not limited to 100. Any score may be deemed as full mark. The practice interface has a timer which is used to count the time being used only for the practice of the first time of a selected round. Enter an exercise number in the box of “go to [symbol] exercise” and execute, the user can directly go to that exercise. The “Page up” and “Page down” keys are set for the content of the answer area of the preceding page and next page. “Preceding exercise” and “Next exercise” keys are for entering the preceding and next exercises. “Do afterwards” and “Cancel and redo” keys are effective/ineffective at the beginning. If the student cannot answer any question initially and wants to skip temporarily, and finish other exercises first and returns afterwards to the skipped one, he/she can tick the “Do afterwards” key to store that exercise into the “Do afterwards” exercises. Once an exercise has been stored in the “Do afterwards” exercises, the key becomes ineffective, and the “Cancel and redo” key becomes effective (these two keys may be designed jointly as a switch key). “Add question answering” and “Cancel question answering” keys are effective/ineffective at the beginning. If answering the question by the instructor is desired, tick the “Add question answering” key. When a selected exercise has been stored in the “question answering” exercises, the “Add question answering” key becomes ineffective. Meanwhile the “Cancel question answering” key becomes effective (these two keys may be designed jointly as a switch key). After having entered a selected exercise, the student can answer or modify the answer as desired. Press the “Return” key, the system directly returns to the system selection Home Page. After the last exercise of a selected round has been finished, press the “Next exercise” key, the system pops up a dialog window as shown in FIG. 4k. Depress the “Confirm” key; user can enter the practice page. Exercises that are stored in “Do afterwards” exercises will be automatically placed by the system to the first exercise of the “Do afterwards” exercises, and all exercises contained therein are sequenced according to the serial number in the original round from small to large. If the selected exercise is finished, the “Cancel and redo” key can be pressed. If “Do afterwards” does not have any exercise, the dialog window does not appear. Press “Esc”, enter a dialog window as shown in FIG. 41. In this window only one of the items can be selected. Enter a round number in the Enter Nth. Round frame, the user can go directly to the selected round to continue the practice or modification. The user can also select to go back to the selected round to do modification, then the system automatically positions at the first exercise of the selected round. Press “Confirm” in the dialog window, the rating of each exercise can be evaluated, and the system pops up a rating dialog window before responding to the next mission. When the selected round has opened the next time for practice, the rating will be displayed on the lower left corner of the page. Press “Confirm” key on the rating dialog window, the system enters the next step. If the selected round does not set rating for the exercises, directly go to the next step, and the rating on the lower left corner of the page is ineffective. The rating statistics are valid only for the first practice of the selected round. Modification afterward does not affect the rating. Press the “Esc” key, all exercises or modifications done in the selected round are not counted. The exercises included in the “Add question answering” also are not counted. This is equivalent to not having entered the selected round, and the system returns to the selection Home Page. When entering the selected round for the second time and entering the exercise modification page, the answering area is changed as shown in FIG. 4m. In this area, “Answer Finished” is the answer selected for answering the exercises at the first time. It relates to the rating of the selected round, hence cannot be changed. If the answer were mistaken, the student is permitted to alter the answer one more time. After the alteration has been finished, press the “Evaluation” key to determine whether the alteration is correct. A notation may be given on a lower section to indicate whether the altered answer is correct; if incorrect, altering may be continued.

Refer to FIGS. 4n through 4p for the question answering interfaces. After having entered the question-answering module, a page as shown in FIG. 4n is displayed. The instructors and students are allowed to enter this interface through their names and passwords. Course selection includes a pull down list, which contains confirmed and input courses. The lower half section has two sets of selections. Each set allows only one selection. If “Answer question by round” is selected, the “□th. Round” behind is activated. Enter a round number in the box, and confirm, the user can directly enter the selected round. If no round number is entered, the system treats it as the first round. If a wrong round number is entered after the ‘confirm’ key is pressed, the system automatically pops up a highlight frame to report error. If necessary, the system can highlight a total round number to avoid the entered round number exceeding the allowable range. After having finished ‘selection’, press the “Confirm” key, the user can enter the corresponding page. If no item is found matching the selected condition, the system automatically brings out a corresponding message. Depress “Esc”, the system returns to the main interface.

Refer to FIG. 4o for the question answering main interface. If “Answer question based on error rate” is selected (in the precious page, selecting “All exercises of each round” shows only “Total exercise number” in the status fields, but does not have “This round”. Press the “Exercise error table” key, an exercise error table sequenced by the number of people making mistake, from large to small, is shown as follows:

| | | Original | No. of | No. of | |
|---|---|---|---|---|---|
| Sequence | Original | Exercise | Mistaken | People | Error |
| No. | Round | No. | People | Practiced | rate |
| 1 | 5 | 8 | 14 | 20 | 70% |
| 2 | 5 | 3 | 12 | 20 | 60% |
| 3 | 5 | 11 | 9 | 20 | 45% |
| 4 | 5 | 7 | 5 | 20 | 25% |

Enter a number in the box of go to [symbol] that represents the Sequence No. of the “Exercise error table” and execute, enter the exercise represented by the selected sequence number.

If “All exercises of each round” is selected, the field of the “Original round” in the “Exercise error table” indicates the number of each round. The number of “No. of people practiced” may be not the same, however, the list is still sequenced by the number of people who made mistakes.

If a selected exercise is skipped by one student, and the answer is empty, it is counted in the No. Of Mistaken people.

If two exercises have the same number of people making mistakes, the error rate is sequenced from high to low. If the error rates are equal, select the original round number from small to large. If the original round numbers are same, select the original exercise number from small to large.

In the question answering main interface, the item of “1st. exercise (No. of Mistaken people: 14)” means that it is the first exercise in the “Exercise error table”. The “8” in the Exercise input area indicates that the selected exercise is 8th in the original round. The 5th Round is shown in the status fields at the upper section. The correct answer area displays the correct answer of the exercise. In the analysis steps area, press the “Analysis” key, the 1st. step is displayed. If there is no “Layer” step analysis, total analysis contents are displayed. Meanwhile, the “Next step” key is ineffective. If there is no analysis content, press the “Analysis” key, the system highlights “No analysis content”. “Modify” and “Delete” keys can only be used by people who have the authorization to input exercises (namely instructors). If students try to access, the system will highlight. Press the “Modify” key; the instructor can modify the exercise, answer and analysis content. The modified content directly affects the original exercise of the original round. Press the “Delete” key, the systems highlights “Confirm to delete”. Once confirmed, the exercise is deleted from the question answering, while the original exercise in the original round still exists. Press the “Preceding/Next exercise” key, the user can enter the preceding/next exercise. When reaching the first exercise or the last exercise, the “Preceding/Next exercise” keys are ineffective. Press the “Return” key, the system returns to the main interface. When a selected round or a selected exercise or all exercises of other modules are deleted, the corresponding exercises in the question answering also are deleted.

Press the “OK” key, FIG. 4p is displayed. The selection interface has two sets of options. Only one item can be chosen in each selection set. If the finished answers are targeted to all exercises in every round, the option “1. Enter the next round” in the selection frame of the second set is ineffective. When “5. Exit” is confirmed, the system returns to the main interface of each module. If “Store the answer based on the bookmark” is selected, the characters in the status fields changed to “. Store the answer based on the bookmark”. The key on the right side is for the “Bookmark storing table”. The table format is as follows:

| | | Original | | No. of | Bookmark |
|---|---|---|---|---|---|
| Sequence | Original | Exercise | Number of | People | store |
| No. | Round | No. | Bookmarks | Practicing | rate |
| 1 | 5 | 8 | 14 | 20 | 70% |
| 2 | 4 | 5 | 12 | 18 | 67% |
| 3 | 1 | 2 | 9 | 22 | 41% |
| 4 | 3 | 9 | 5 | 25 | 20% |

The foregoing table is sequenced by the bookmark-storing number. If the bookmarks are equal, sequence by the bookmark-storing rate. If the storing rates are the same, select the original round sequence. If the original round sequences are the same, select the original exercise number. “No. of Mistaken people: 14” in the previously table is changed to “Bookmark stored No.: 14”.

Refer to FIGS. 4q and 4r for schematic views of information table interfaces. After having entered the information table module from the main interface, a dialog window shown in FIG. 4q is displayed. After having selected an item and having pressed the “Confirm” key, enter a corresponding list. Press the “Return” key, and return to the main process. The member information table is as follows:

Total 5 instructors, 5 students, 5 courses

| Sequence | Name | Title | Course | Round |
|---|---|---|---|---|
| 1 | Mary | Instructor | English | 3 |
| 2 | Chen Chin | Instructor | Mathematics | 5 |
| 3 | Chen Chin | Instructor | English | 7 |
| 4 | Li yen | Instructor | Physics | 8 |
| 5 | Wang Fei | Instructor | Mathematics | 6 |
| 6 | Chao yen | Instructor | Chemistry | 5 |
| 7 | Linda | Student | English | 3 |
| 8 | Linda | Student | Mathematics | 8 |
| 9 | Linda | Student | Physics | 3 |
| 10 | Linda | Student | English | 7 |
| 11 | Rose | Student | English | 5 |
| 12 | Li Dan | Student | Mathematics | 0 |
| 13 | Li Dan | Student | English | 3 |
| 14 | Yang Sing | Student | Physics | 6 |
| 15 | Yang Sing | Student | English | 6 |
| 16 | Chou Jei | Student | Mathematics | 11 |

Where:
1. The top line lists the summary formation.
2. The instructors are listed ahead of the students.
3. The list of the instructors or students is sequenced by Chinese phonetic characters. The English names are listed by alphabetic sequence. The English name is listed ahead the Chinese name.
4. The round number corresponding to the instructor indicates that the instructor is the author of the exercises in the selected round. The round number corresponding to the student indicates that the student has taken the exercises of the selected round.
5. One instructor may be the author of different courses. One student may take exercises of different courses. The courses are sequencing Chinese phonetic characters. If the instructor enters a course name in English, it is listed ahead the Chinese course name.
6. If one course is named both in Chinese and English, the system treats it as two courses.
7. If two instructors author rounds of exercises for the same course, such as two instructors have authored mathematics for 5 and 6 rounds respectively, then mathematics has 11 rounds totally. In the statistics of students, the maximum round of mathematics is the total round number authored by the two instructors, namely 11 rounds.
8. Tick the “Course” by mouse, all information may be re-sequenced by the course, but the instructors are still listed ahead of the students.

Enter the “Achievement statistics” menu; an interface shown in FIG. 4q is displayed. After having picked the exercises of a selected round of a selected course authored by a selected instructor, and confirmation is done, enter an Achievement statistics table. The “Return” key aims to return to the main interface of the information table module. An example of the Achievement statistics table is shown as follows:

Instructor: Li Yen, Physics, Round 5,
Total 15 exercises, Full mark: 125

| Sequence | | Student | Mistaken | Bookmark | |
|---|---|---|---|---|---|
| No. | Name | No. | No. | No. | Rating |
| 1 | Linda | 003 | 5 | 3 | 75 |
| 2 | Rose | 008 | 2 | 4 | 110 |
| 3 | Li Dan | 014 | 4 | 6 | 98 |
| 4 | Yang Sing | 006 | 4 | 5 | 94 |
| 5 | Chou Jei | 009 | 7 | 3 | 69 |

The table is sequenced by name according the rules of the Member information table.

Tick the mouse on the Name, student No., mistaken No., Bookmark No., and rating, all information may be re-sequenced according to the selected category.

After entered, a dialog for Achievement statistics table is displayed; once confirmed, an error summary table is displayed as follows:

Instructor: Li Yen, Physics, Round 4, Total
5 exercises, Total participants: 12

| Exercise No. | No. of Mistaken People | No. of Bookmarked people |
|---|---|---|
| 1 | 2 | 3 |
| 2 | 4 | 3 |
| 3 | 1 | 2 |
| 4 | 3 | 4 |
| 5 | 5 | 6 |

The exercise number sequences this table. Tick the No. of mistaken people and No. of bookmark people by a mouse, all information may be re-sequenced according to the selected category.

The remote instruction according to the invention may also serve as instructor's teaching materials (to save publishing time) and planning for student exercises. One set of software may be used in one class. For an instructor who teaches more than one class at the same time, multiple copies of exercise database contents may be made if necessary. And through the network, the instructor can distribute and transmit the prepared exercises to the students as homework. The students can submit the finished exercises to the instructor. Hence the instructor does not have to correct the homework. The achievement statistics and information of all students are available in the next class. It is more convenient for the instructors and students to use.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A remote instruction system for automatically accessing exercise data to generate comprehensive interactive instructions between instructor ends and student ends, comprising:
an exercise database automatically generated based on data input by instructors for students to learn and the instructors to teach;
an exercise editing module for the instructor ends to do editing for exercises in the exercise database;
a student learning module for accessing the exercises in the exercise database and displaying the exercises on the student ends to allow the students to do practice and test, and also get test results;
an error statistics module for performing statistics of the test results at the student ends and marking questioned exercises based on statistic results;
a question marking module linking to the student learning module to receive questioned exercises marked by the students; and
a question answering module linking to the instructor ends and the student ends to implement teaching activities and allow the instructors to teach the questioned exercises and answer student's questions.

2. The remote instruction system of claim 1, further including a member management module to provide registration for the instructors and the students, and enter identifications and authentication.

3. The remote instruction system of claim 1, wherein the exercise database further is connected to an exercise generation module which automatically generates the exercises and includes:
a structure setting module to set up the structure of the exercise database according to teaching requirements;
an interface generation module to generate user interfaces according to the structure of the exercise database structure;
an input receiving module linking to the interface generation module to receive exercise data input by the instructors through the user interfaces; and
an exercise data generation module to store the instruction contents in corresponding locations of the exercise database.

4. The remote instruction system of claim 1, wherein the editing includes inputting, modifying and deleting operations.

5. The remote instruction system of claim 1, wherein the error statistics module further includes calculating student achievements based on error statistics.

6. The remote instruction system of claim 1, wherein the question-answering module includes setting up an online answering room for the instructors and the students to implement video and audio communications.

7. The remote instruction system of claim 1, wherein the question answering module further includes setting up an answer database by the instructors based on the questioned exercises, the answer database providing displays on the student ends.

8. The remote instruction system of claim 1, wherein the question answering module further includes an interactive electronic whiteboard.

9. A remote instruction method for automatically accessing exercise data to generate comprehensive interactive instructions between instructor ends and student ends, comprising:
receiving data input by instructors and automatically generating a desired exercise database based on the data for student learning and instructor teaching;
accessing an exercise from the exercise database and sending to the student ends;
practicing and testing contents of the exercise by students, and marking questioned exercises;
performing error statistics based on the testing results and marking the questioned exercises; and
establishing an online connection between the instructor ends and the student ends for the instructors to teach the questioned exercises.

10. The method of claim 9 further including performing registration and authentication for the instructors and the students.

11. The method of claim 9, wherein the automatically generating a desired exercise database based on the data for student learning and instructor teaching further includes the steps of:
establishing a structure of the exercise database;
generating corresponding user interfaces according to the structure of the exercise database;
entering the exercise data by the instructors through the user interfaces; and
receiving the exercise data and storing the exercise data in corresponding locations of the exercise database.

12. The method of claim 9 further including editing contents of the exercise database by the instructors, including modifying and deleting operations.

13. The method of claim 9, wherein the performing error statistics further includes calculating student achievements based on the error statistics.

14. The method of claim 9, wherein the establishing an online connection between the instructor ends and the student ends for the instructors to teach the questioned exercises includes implementing video and audio communications.

15. The method of claim 9, wherein the instructors to teach the questioned exercises is accomplished by exchanging with the students through an electronic whiteboard.
